(19) United States
(12) Patent Application Publication
(10) Pub. No.: US 2010/0325468 A1
(43) Pub. Date: Dec. 23, 2010

(54) Memory Unit Access

(75) Inventor: Richard Stephans, Surrey (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/521,575

(22) PCT Filed: Dec. 28, 2006
(86) PCT No.: PCT/IB06/03785

§ 371 Date: Aug. 18, 2010

(51) Int. Cl. G06F 1/04

(52) U.S. Cl. 713/600

(57) ABSTRACT

A system comprises a control unit and a circuit. The circuit comprises an input clock connection for receiving a clock signal from the control unit, a first output clock connection for providing the clock signal to a first memory unit, a second output clock connection for providing the clock signal to a second memory unit, a control connection for receiving a control signal from the control unit. The circuit further comprises multiplexer circuitry connected to the input clock connection, the first and the second clock connections and the control connection. The multiplexer circuitry is configured to react to the control signal from the control unit by providing the clock signal to the first memory unit or the second memory unit. In other words, a clock signal is multiplexed in such a way that only one memory unit at a time receives the clock signal. An effect of this is that in a system having two or more memory units, unique access is provided to one memory unit at a time.

### TECHNICAL FIELD

The present invention relates to controlling digital circuits including controlling access to memory units.

### BACKGROUND

Communication devices have during the last decades evolved from being more or less primitive telephones, capable of conveying only narrow band analogue signals such as voice conversations, into the multimedia mobile devices of today capable of conveying large amounts of data representing any kind of media. For example, a telephone in a GSM, GPRS, EDGE, UMTS or CDMA2000 type of system is capable of recording, conveying and displaying both still images and moving images, i.e. video streams, in addition to audio data such as speech or music.

Such functionality typically requires the use of mass memory units. Very often, the interface units used to control these mass memories are the Secure Digital (SD) and MMC interfaces. However, in many devices there is only one interface available to control several mass memory units in the form of memory cards as well as hard disk drive units. These interface units control access to the memory units by way of more or less complex signalling sequences that often are time consuming and also complex.

Therefore there is a need to provide a more simple solution of how to access several memories from a single interface unit.

### SUMMARY

An object of the invention is to overcome drawbacks of prior art arrangements.

This object is achieved in different aspects by way of arrangements and a method according to the appended claims.

Hence, in a first aspect there is provided a system comprising a control unit and a circuit. The circuit comprises an input clock connection for receiving a clock signal from the control unit, a first output clock connection for providing the clock signal to a first memory unit, a second output clock connection for providing the clock signal to a second memory unit, a control connection for receiving a control signal from the control unit. The circuit further comprises multiplexer circuitry connected to the input clock connection, the first and the second clock connections and the control connection. The multiplexer circuitry is configured to react to the control signal from the control unit by providing the clock signal to the first memory unit or the second memory unit.

Embodiments of the system may be such that they comprise both the first memory unit and the second memory unit.

Other embodiments of the system may be such that they comprise the first memory unit and being configured with a connector for the second memory unit.

Furthermore, the system may comprise user interface circuitry and radio communication circuitry that are configured to enable communication in a radio communication network.

The circuit may further comprise a third output clock connection for providing the clock signal to a third memory unit and said multiplexer circuitry being connected to said third clock connection and further configured to react to the control signal from the control unit by providing the clock signal to the first memory unit, the second memory unit or the third memory unit.

In another aspect there is provided a circuit comprising an input clock connection for receiving a clock signal from a control unit, a first output clock connection for providing the clock signal to a first memory unit, a second output clock connection for providing the clock signal to a second memory unit, a control connection for receiving a control signal from the control unit, and multiplexer circuitry. The multiplexer circuitry is connected to the input clock connection, the first and the second clock connections and the control connection. The multiplexer circuitry is configured to react to the control signal from the control unit by providing the clock signal to the first memory unit or the second memory unit.

In a further aspect there is provided a method comprising providing a clock signal and a control signal in a control unit, receiving, in a circuit connected to the control unit, the clock signal and the control signal, and reacting to the received control signal from the control unit by providing the clock signal to a first memory unit or a second memory unit.

In other words, a clock signal is multiplexed in such a way that only one memory unit at a time receives the clock signal. An effect of this is that in a system having two or more memory units, unique access is provided to one memory unit at a time.

An advantage of the invention is that it at least provides a more flexible and simple way of utilizing multiple memory units. For example, when realized in a device having multiple attached memory units, the circuitry for controlling access to a specific memory unit may be less complex than in prior art devices.

### BRIEF DESCRIPTION OF THE DRAWINGS

FIG. 1 is a schematically illustrated system comprising memory units.

### PREFERRED EMBODIMENTS

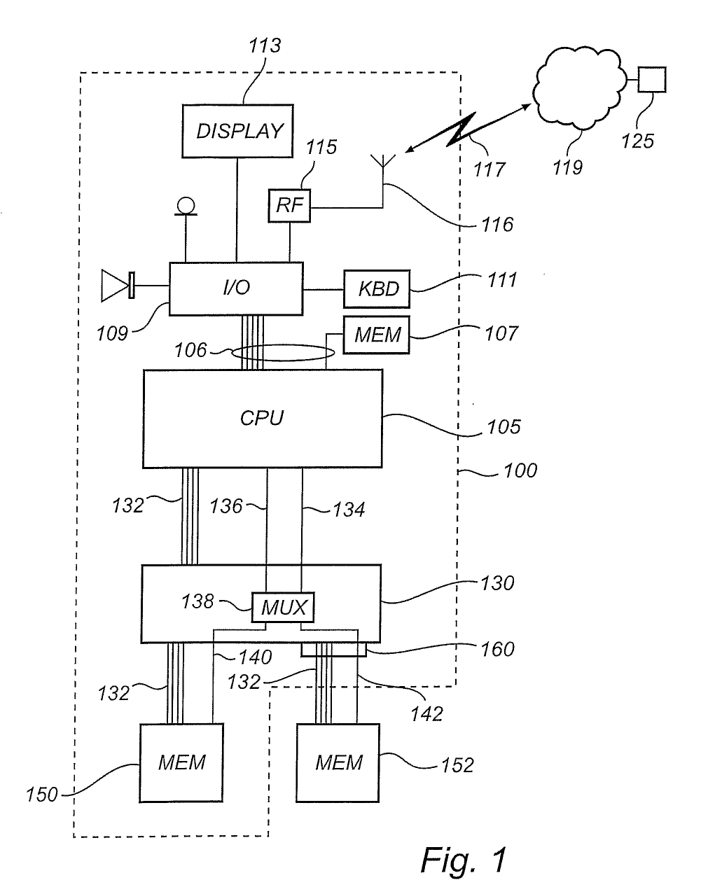

An embodiment of a system 100 is illustrated in FIG. 1. The system 100 may form part of a communication terminal, such as a mobile phone or the like, and includes a number of processing and interfacing blocks. A processing unit 105 is connected via a bus 106 to a number of units, including a first memory unit 107 and an input/output unit 109. The input/output unit 109 in turn is configured to convey information between a keyboard 111, a display 113 and a radio transceiver unit 115 and the processing unit 105. The radio transceiver unit 115 is capable of establishing and maintaining a radio connection with a radio communication network 119 through an antenna 116 via an air interface 117. Information may be exchanged between the system 100 and a second communication entity 125, which may be another communication terminal or a service provider etc., as is known in the art.

The processing unit 105 is also connected to a first mass memory unit 150 and a second mass memory unit 152 via a bus 132 and a mass memory interface circuit 130. As indicated by the dashed line in FIG. 1, the first mass memory unit 150 forms part of the system 100, i.e. it is configured as an “internal mass memory unit”, whereas the second mass memory unit 152 is indicated as being “external” to the system 100. To further indicate the “external” character of the second mass memory unit 152, a memory connector 160 is schematically illustrated. Many implementations of, e.g., communication terminals, PDAs etc., includes such a combination of internal and external (and in fact removable and replaceable) memory units. As the skilled person will realize, the mass memory units 150, 152 may be any type of flash memory, such as a Multi Media Card (MMC), Secure Digital (SD) or any appropriate type of hard disk etc.

The processing unit 105 also provides a clock signal line 134 and a command signal line 136 to the interface circuit 130. The clock signal line 134 and the command signal line 136 are connected to a multiplexer 138, which forms part of the interface circuit 130. The multiplexer 138 is configured such that it provides a clock signal, provided on the clock signal line 134 from the processing unit 105, on either a first clock output line 140 or a second first clock output line 142. Selection of which clock output line 140 or 142 to activate, is made in response to a clock selection command from the processing unit 105 on the command signal line 136.

By issuing a clock selection command from the processing unit 105, multiplexing the clock signal is possible in such a way that only one of the mass memory units 150, 152 at a time receives the clock signal. This has an effect that the system 100 having multiple mass memory units, unique access is provided to one of the mass memory unit at a time.

Although the system in FIG. 1 only illustrates two mass memory units 150, 152, alternative embodiments of the system 100 may involve arrangements of any number of mass memory units, internal and/or external. For example, a third memory unit may be arranged with a connection to the bus 132 and to the multiplexer 138.

The processing unit 105 is configured with control software, including software that is capable of controlling access to the mass memory units 150, 152. This access control software performs a method including control sequences that provides the clock signal and a control signal. The interface circuit 130 is configured with logic circuits that reacts to the control signal from the processing unit 105 and thereby receives the clock signal and the control signal. Upon reception of the control signal and the clock signal, the interface circuit 130 reacts by providing the clock signal to either the first mass memory unit 150 or the second mass memory unit 152 and thereby providing unique access to one mass memory unit at a time.

1. A system comprising:
a control unit,
a circuit comprising:
an input clock connection for receiving a clock signal from the control unit,
a first output clock connection for providing the clock signal to a first memory unit,
a second output clock connection for providing the clock signal to a second memory unit,
a control connection for receiving a control signal from the control unit,
multiplexer circuitry connected to the input clock connection, the first and the second clock connections and the control connection, the multiplexer circuitry configured to react to the control signal from the control unit by providing the clock signal to the first memory unit or the second memory unit.

2. The system of claim 1, comprising the first memory unit and comprising the second memory unit.

3. The system of claim 1, comprising the first memory unit and configured with a connector for the second memory unit.

4-7. (canceled)

8. The system of claim 1, comprising user interface circuitry and radio communication circuitry that are configured to enable communication in a radio communication network.

9. The system of claim 1, wherein said circuit further comprises a third output clock connection for providing the clock signal to a third memory unit and wherein said multiplexer circuitry is also connected to said third clock connection and further configured to react to the control signal from the control unit by providing the clock signal to the first memory unit, the second memory unit or the third memory unit.

10. A circuit comprising:
an input clock connection for receiving a clock signal from a control unit,
a first output clock connection for providing the clock signal to a first memory unit,
a second output clock connection for providing the clock signal to a second memory unit,
a control connection for receiving a control signal from the control unit,
multiplexer circuitry connected to the input clock connection, the first and the second clock connections and the control connection, the multiplexer circuitry configured to react to the control signal from the control unit by providing the clock signal to the first memory unit or the second memory unit.

11. A method comprising:
providing a clock signal and a control signal in a control unit,
receiving, in a circuit connected to the control unit, the clock signal and the control signal,
reacting to the received control signal from the control unit by providing the clock signal to a first memory unit or a second memory unit.
